(19) United States
(12) Patent Application Publication
(10) Pub. No.: US 2015/0271167 A1
(43) Pub. Date: Sep. 24, 2015

(54) Method of Altering Authentication Information to Multiple Systems

(71) Applicant: Daniel Kalai, New York, NY (US)

(72) Inventor: Daniel Kalai, New York, NY (US)

(21) Appl. No.: 14/220,687

(22) Filed: Mar. 20, 2014

(51) Int. Cl. H04L 29/06; H04L 29/08

(52) U.S. Cl. CPC H04L 63/083; H04L 67/10

(57) ABSTRACT

A method and apparatus for changing user information associated with multiple services using a single interface.

### CROSS-REFERENCE TO RELATED APPLICATIONS

Not applicable.

### STATEMENT CONCERNING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

Usernames (or login names) and passwords are widely used for authentication in Internet applications such as websites, applications, computers, and networks. In addition, passwords are used in a variety of non-Internet applications such as codes for buildings, padlocks, credit cards, voicemail, home alarms, mobile phones, etc. Thus, users must memorize and manage a variety of usernames and passwords day-to-day. As a result, password management has become a burden for users, who are at the very least, inconvenienced, when a password is lost or compromised.

There are many instances in which a user will be motivated to change their username or password. For instance, a username and password may have been compromised by a security breach. To change a username or password, the user must log in to the system of the associated service and manually change the desired information (i.e. username or password). In the event that the user wishes to alter their username and password associated with multiple services, the user must log in to the system associated with each service one at a time and manually change the desired username or password. This manual process can be extremely time consuming when a user wants to change information on more than one system.

### BRIEF SUMMARY OF THE INVENTION

A method of changing user information associated with a plurality of services. The method comprises the steps of (1) receiving a first indication from a user that indicates that said user would like to change user information that is currently associated with a first service, (2) receiving a second indication from said user that indicates that said user would like to change user information that is currently associated with a second service, wherein said first and second indications are received from a single user interface, (3) communicating with said first service, wherein said communications include new user information to be associated with said first service and (4) communicating with said second service, wherein said communications include new user information to be associated with said second service.

### BRIEF DESCRIPTION OF THE SEVERAL VIEWS OF THE DRAWING

FIG. 1 is an exemplary view of a user template operating according to the principles of the present invention.

FIG. 2 is an exemplary view of a user template operating according to the principles of the present invention, showing feedback.

FIG. 3 is a network diagram of components operating according to the principles of the present invention.

### DETAILED DESCRIPTION OF THE INVENTION

The following is a detailed description of the principles of the present invention. The detailed description includes a description of the present invention as well as descriptions of preferred and alternative embodiments of the invention. These preferred and alternative embodiments are provided to illustrate aspects of the invention. However, the invention should not be limited by the disclosed embodiments as further implementations would be understood by one of ordinary skill in the art.

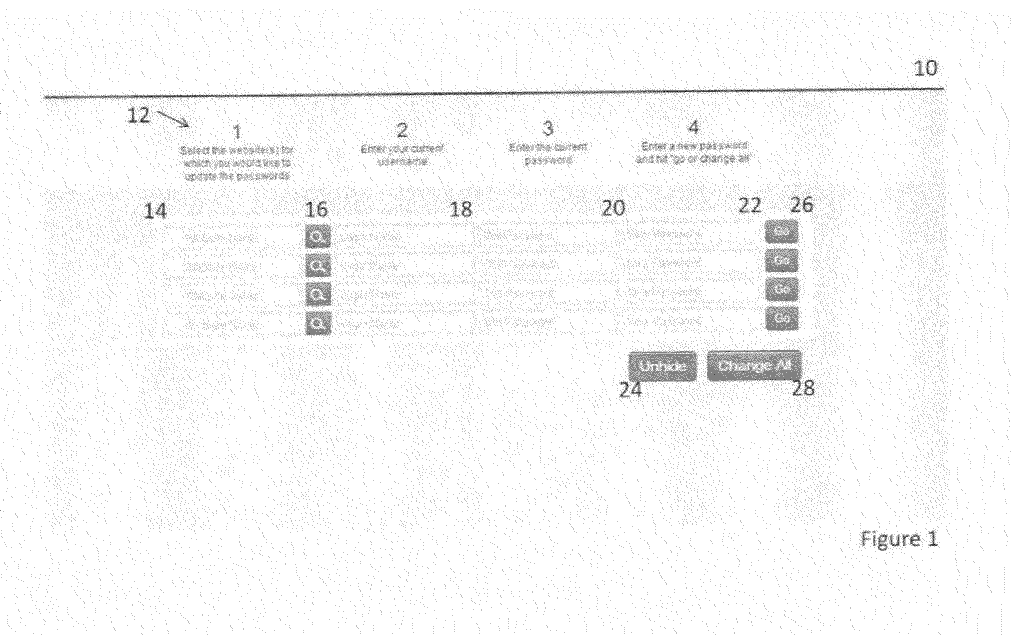

The present invention can be accessed by a user in a number of ways. A user may place a phone call, send an email, use a computer program, mobile application, biometric input device and/or website to provide the information needed in order to change user information associated with multiple services. FIG. 1 is an illustration of a user interface in a preferred embodiment of the present invention. Such user interface 10 may be implemented as an email template, local computer program, mobile application or website.

A first section 12 of the user template 10 provides instructions to help a user understand the steps that need to be performed in order to change user information associated with multiple services. In the current example, the user template 10 allows the user to change passwords associated with multiple services. The first section 12 explains to the user that they may “[s]elect the website(s) for which you would like to update the passwords,” “[e]nter your current username,” “[e]nter your current password” and “[e]nter a new password and hit ‘go’ or ‘change all’.” Accordingly, the template 10 includes service boxes 14 as well as service search buttons 16. The user may enter the name of a service by typing the name of that service into one of services boxes 14. The user may enter the name of the entire service, or the name of the service may be predicted based on the user input of only part of the name of the service using a standard auto-complete algorithm as is know in the art. Alternatively, the user may select a service search button 16. When such button is selected the user is presented with a list of services. The user can then select a service from that list to populate a first entry. In an alternate embodiment, a user may select multiple services from the service list. Such an implementation may be useful when the user information associated with multiple services is identical.

Once a service is selected, the user may input their current username/Login Name for the identified service in a user identification box 18. Similarly, the user may input their current password for the identified service in current password/Old Password box 20. In the current exemplary user template 10, the user may input a new password for the identified service in New Password box 22. For security, the current and new password may be obscured as it is entered. However, the user may select the unhide button 24 in order to see the alphanumeric data entered into current password box 20 and new password box 22.

The user may then repeat the process above in order to input the required data to change information related to other services. Specifically, the user may enter the name of the service using a service box 14 or a search button 16, a current associated username in a user identification box 18, a current password in current password box 20 and a new password in new password box 22. Once the user has entered all of the required information for one or more services for which it would like to change their user associated information, the user may select go button 26 in order to begin changing the user associated information for an associated service. In addition, the user may select change all button 28 in order to begin changing the user associated information for all the services identified by the user. In this way, the user can change user associated information, such as a password, for multiple services from a single location.

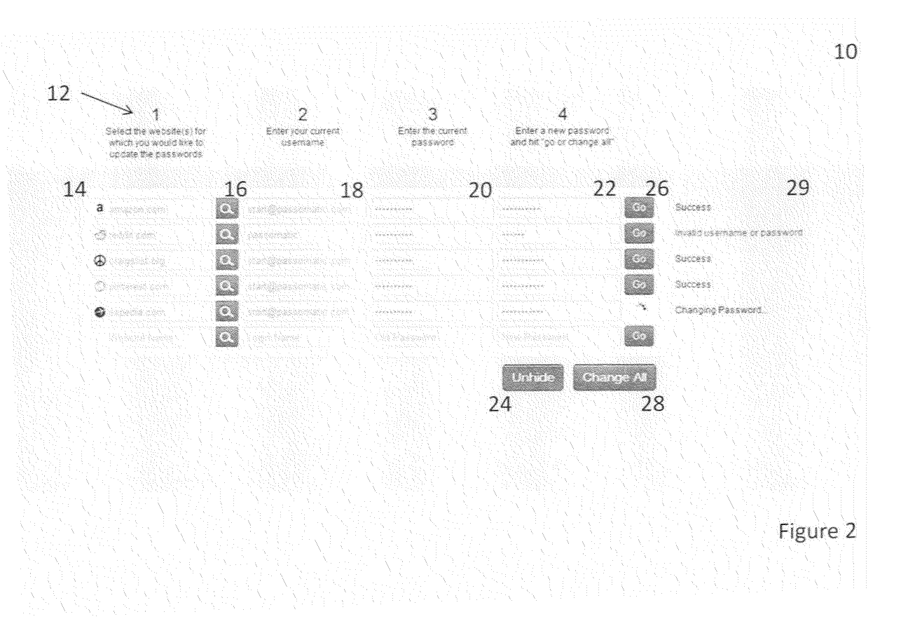

Turning to FIG. 2, feedback can be given to the user as passwords are changed. Specifically, feedback 29 can be given as each new password is associated with each service. For instance, while a password is being changed, feedback 29 may indicate “changing password.” If a password is successfully changed, the feedback 29 may indicate “success.” If a username of current password was entered unsuccessfully, the feedback 29 will indicate “invalid username or password.” The user may correct the associated username in user identification box 18 or password in current password box 20.

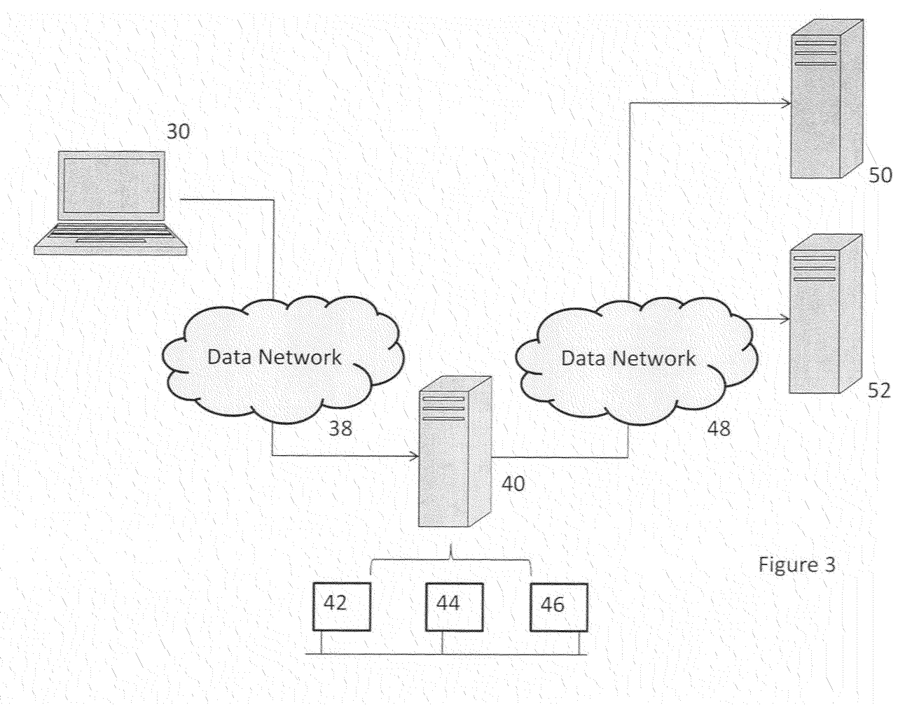

While FIGS. 1 and 2 describe a user interface 10 for changing a user password, it should be understood that the user interface 10, and the methods below, may be used to change any user information that is associated with a service. Such user information can include a username, password, phone number, address, credit card, email address, alternate email address, PIN number, security question, electronic payment information or forms of personal user information. In most implementations, the user will have to include authentication information so that the server 40 (see FIG. 3) can interact with the service on the user's behalf and effectuate the desired change.

The present invention uses the information input by the user in FIGS. 1 and 2, such as a service name, username, current password and new password, to change user information associated with a service. This can be accomplished in many ways. In one embodiment, a server can be used to receive the user input from a website and effectuate the change of user information associated with the identified service. In another embodiment, an email server can be used to receive the user input from an email from the user and effectuate the change of user information. In yet another embodiment, a software program can run locally on the same machine that the user uses to input their information. Other embodiments will be understood by those in the art.

After receiving the information from the user, the user associated information related to a service can be changed in many ways. In a first embodiment, the present invention interacts directly with the identified service, such as by using an application program interface (“API”). In another embodiment, the present invention automates the steps that the user would have had to take in order to change the identified user associated information with the identified service. For example, the present invention can simulate navigating to a service's website, clicking on a link in order to change the user's information, and entering the user's information in the appropriate places in order to change certain user information. In yet another embodiment, the process of changing the user's information can be executed manually, by persons that navigate to the service's webpage, finding the appropriate link in order to change the users' information, and inputting the user's information to effectuate such change. In a further embodiment the present invention may deliver the user's information to the specified service so that the service itself can effectuate the desired change.

FIG. 3 illustrates a user computing device and server operating according to the principles of the present invention, as they interact with a service. User computing device 30 provides a user with the user template 10 illustrated in FIGS. 1 and 2. As described with reference to FIGS. 1 and 2, a user can use user template 10 on a computing device 30 to identify user information such as a service, current user information and new user information. User computing device 30 may be a desktop personal computer, a laptop computer, a tablet, mobile phone or other computing device. The user information is transmitted from computing device 30 to server 40 over a data network 38, such as the Internet.

Server 40 includes a communication port 42, CPU 44 and memory 46. Server 40 receives the user information from the data network via communication port 42. Communication port 42 passes that information to CPU 44.

As described above, a server operating according to the principles of the presented invention may effectuate the desired change of user information in many ways. Each service may require a different method of changing the desired user information. For example, a first identified service may allow Server 40 to change the desired user information directly using an API, while a second identified service may require Server 40 to simulate user interaction to effectuate the desired change. Thus, CPU 44 parses the user information to identify the service input by the user and identify an associated method of service interaction. The associations between services and methods of interaction may be stored in memory 46.

Server 40 interacts with service servers 50 and 52, each associated with one of the user identified services, over a data network 48 in order to effectuate the desired change of user information. The data network 48 may be the same or different than data network 38. Server 40 sends status messages back to computing device 30 to update the user regarding the status of the desired changes. For instance, server 40 may notify computing device 30 that the user information associated with a first service was successfully changed, but that the user information associated with a second service was not able to be authenticated and thus the user should check the input authentication credentials and try again.

While the above embodiment describes the interaction between a server 40 and the service servers 50 and 52, it should also be understood that the capabilities described above can also reside in the user's computing device 30 and that, consequently, the interaction may be implemented between user computing device 30 and service servers 50 and 52.

Once the server 40 has completed the task of changing the requested user information, the server 40 may delete from its system (e.g. the associated memory 46) the user information that was input into the user template 10 and used to change the user information for the specified services. The server 40 may additionally send a notification to user computing device 30 to notify the user that their personal user information has been removed from the server 40.

While the present invention has been described above with numerous embodiments, it should be understood that the principles of the present invention contemplates alternative embodiments that embody the spirit of the present invention and allow a user to change information related to multiple services from a single interface. For instance, the present invention may be coupled with a password management service, such that a user can change all of their passwords by simply inputting a single new password for all their associated services. In another example, the present invention may include automatic changes of user information. In another example the user can delete or suspend multiple accounts. In yet another example the user can create multiple accounts. As an additional feature, the user can respond to security questions, captchas, token inputs using the same interface described above. For instance, a user can set a schedule for changing their password. In yet another example, a user can input a new password to be used in case of an emergency, such that when their current password is compromised, they need only send a single “change” request to the present invention to change their passwords to their emergency password. In another example, the present invention can create new user passwords without input from the user and subsequently notify the user of the computer generated password. Such an embodiment may be especially useful in creating secure passwords. Such an embodiment may also be especially useful when the present invention is coupled with a password management service, that automatically remembers these new computer generated passwords for the user and inputs them into the login fields of the associated services.

1. A method of changing user information associated with a plurality of services, comprising the steps of:
receiving a first indication from a user that indicates that said user would like to change user information that is currently associated with a first service;
receiving a second indication from said user that indicates that said user would like to change user information that is currently associated with a second service, wherein said first and second indications are received from a single user interface;
communicating with said first service, wherein said communications include new user information to be associated with said first service; and
communicating with said second service, wherein said communications include new user information to be associated with said second service.

2. The method of claim 1, wherein at least one of said first and second indications includes user authentication information.

3. The method of claim 1, wherein at least one of said first and second indications includes an identification of said first and second services.

4. The method of claim 1, wherein at least one of said first and second indications includes said user information that is currently associated with said first or second service.

5. The method of claim 1, wherein at least one of said first and second indications includes said new user information to be associated with said first or second service.

6. The method of claim 1, wherein said user information that is currently associated with said first or second service is a user password.

7. The method of claim 1, including the step of retrieving at least one of said user information that is currently associated with a first or second service from a password management service.

8. The method of claim 1, wherein at least one of said communications with said first or second services simulates interactions that said user would have had to take to manually change said user information.

9. The method of claim 1, wherein at least one of said communications with said first or second services is made using an application program interface.

10. A user profile management system, comprising:
a first communications interface for receiving a first indication from a user that indicates that said user would like to change user information that is currently associated with a first service and a second indication from said user that indicates that said user would like to change user information that is currently associated with a second service, wherein said first and second indications are received from a single user interface; and
a second communications interface for communicating with said first service, wherein said communications include new user information to be associated with said first service, and for communicating with said second service, wherein said communications include new user information to be associated with said second service.
